(19) United States
(12) Patent Application Publication
(10) Pub. No.: US 2017/0344983 A1
(43) Pub. Date: Nov. 30, 2017

(54) BIXCoin: A Secure Peer-to-Peer Payment System Based on the Public Payments Ledger

(71) Applicant: Business Information Exchange System Corp., Rockville, MD (US)

(72) Inventor: Sead Muftic, Rockville, MD (US)

(21) Appl. No.: 15/168,200

(22) Filed: May 30, 2016

(51) Int. Cl. G06Q 20/38; G06Q 20/10; G06Q 20/40

(52) U.S. Cl. CPC G06Q 20/3829; G06Q 20/407; G06Q 20/108; G06Q 2220/00

(57) ABSTRACT

This invention describes a secure peer-to-peer payment system based on the use of a virtual currency, virtual accounts, and a public payments ledger. The virtual currency used in the system is stable, as it is pegged to real-world currencies with unit values equivalent to the national currency of the country of deployment. The virtual accounts are specially designed and cryptographically encapsulated objects that can be opened (created), initially loaded, cleared (suspended/terminated), and used (credited/debited) for direct account-to-account payments. Validation of payment transactions is supported by a public payments ledger that prevents the use of the system by illegal or unauthorized users, eliminates illegal payments, prevents the use of illegal currency, and double-spending. The ledger contains instances of virtual accounts, so validation of payments is instantaneous based on the validation of the balances of the two participating accounts. Validation protocol can be at several assurance levels, reflecting user needs, financial policies, and the value of the payment transactions. The system has no third parties and uses community validation protocols. Furthermore, it does not store any secret, private, or sensitive user credentials, so it is not vulnerable to any type of attack. It provides full security, privacy, and anonymity for users, their virtual accounts, and their payment transactions.

### TECHNICAL FIELD OF THE INVENTION

This invention is related to the general category of financial transaction systems based on virtual accounts and virtual currencies. More specifically, it describes a system based on the innovative concept of a secure public payments ledger supporting peer-to-peer payment transactions without any third parties, with instantaneous validation and settlement of transactions, and without any risks or vulnerabilities for users of the system.

### BACKGROUND OF THE INVENTION

It is general consensus that peer-to-peer digital transactions performed over the Internet are more efficient than transactions performed w ith the assistance of third parties. The advantages of such transactions arc not only in terms of their execution speed and efficiency, but also in terms of reduced operational complexities and costs, and improved reliability. An especially important problem in today's complex network infrastructures is their vulnerabilities to attacks, penetrations, and fraud: peer-to-peer transactions greatly reduce or even eliminate such vulnerability, since they do not have any intermediate components between transaction partners.

Examples of peer-to-peer applications and transactions include files or music sharing, the exchange of instant messages, or online chats. The introduction of the Bitcoin concept significantly increased the interest and research into such transactions. However, before utilizing the advantages of these types of applications and transactions, their core problems must be solved, such as their correctness, validity, security, anonymity, outcomes, and compliance to rules and policies. All of these problems either do not exist or are easily solvable if the services of third parties are used. Therefore, one of the main problems with peer-to-peer transactions, that do not use the assistance of third parties, is their overall correctness and validation. The contradiction for such transactions is that parties, which are mutually suspicious, must be able to validate the correctness of their partners and transactions without the assistance of any other third party. This is especially important for payment transactions where the illegal use of currencies, the use of illegal currencies, protocol cheating, double-spending, and other problems must be addressed and efficiently eliminated in order to use the system.

Bitcoin claims to solve some of these problems. It is an anonymous payment system that uses the concept of a public transactions ledger—called a blockchain—to perform and verify payment transactions. Its blockchain has a specific structure, it uses specific protocols for its creation, distribution, and use, and its structure is suitable primarily for payment transactions. Some alternative innovative ideas have been promoted to use the same concept and the existing operational Bitcoin infrastructure to perform other types of peer-to-peer and anonymous transactions, including shared file storage, a secure file-sharing system, a document management system with digital notary services, proof-of-existence for documents, and some others.

Although Bitcoin is appropriate for anonymous payments and is operational at the time of this invention, the system has many conceptual and operational problems. In fact, it does not have any of the claimed core features and properties. First, it is not peer-to-peer system, as payment transactions are not exchanged directly between two parties, but are channeled through many intermediate components before they are settled and before they finally reach their recipients. These components are servers comprising the Bitcoin network, mining servers, and mining clients. Second, Bitcoin system is not without the assistance and participation of third parties, as all intermediate components that are located between two transaction partners are not simple passive message-passing components. They actively participate in, and even control, transactions and overall system operations. Third, as research has shown, Bitcoin accounts using public keys are not fully anonymous.

In addition to these conceptual shortcomings and deficiencies, the Bitcoin system has many other operational problems, including small block size, slow transactions throughput, long delays in transactions settlement, currency value volatility, vulnerability/exposure of private cryptographic keys, and vulnerability to cheating by a collaboration of miners. Therefore, to provide the full scope of security and anonymity services for payments and other types of applications, the system requires certain conceptual modifications, improvements, and extensions. Furthermore, even the basic concept is not adequate, since not all applications need transactions to be packaged in blocks or linked in chains.

All these Bitcoin's incorrect and/or invalid claims, conceptual weaknesses, and shortcomings in operational solutions motivated the innovative ideas described in this invention. As many operational experiences, technical reports, and research problems have clearly indicated, the approach to solutions for these problems cannot be minor improvements and modifications of the current concept of the Bitcoin system and procedures. The only solution is to design a conceptually different payment transactions system, which is based on new and different principles, protocols, and procedures. Such a system is described in this invention.

The system described in this invention has several features that are essentially different from the ideas and solutions of the Bitcoin system. It performs payments as truly peer-to-peer transactions without any third-party involvement and without placing trust in any component of the system. Its ledger contains not individual transactions, as in the Bitcoin, but the accounts of system members. The settlement of payment transactions is instantaneous, and transactions are reversible under consensus of the parties or by enforcement of the payment policy. Users do not need to download the full ledger, so bootstrapping new users is not a problem (i.e., users are ready to perform transactions immediately after the installation of user transaction agents). The system does not use public keys as account numbers and therefore does not require private keys to spend currency; thus, fraud by stealing private keys is eliminated, as these keys are not required to perform outgoing transactions. The system does not use cryptocurrencies and cryptographic validation protocols (proof-of-work). Virtual currency used in the system is stable and not volatile, as it is pegged to real-world currencies. The system provides several levels of transaction validation, reflecting user needs, transaction types, transaction amounts, and/or financial policies. The system provides full security, privacy, and anonymity of users and their transactions and guarantees full correctness and legality of payments. The system does not store any of its users' secret or sensitive parameters or crypto credentials, such as passwords, private keys, and tokens, in any form or at any location, so these data are not vulnerable to attack or theft. The core functionality of the system is the transfer of value between two accounts, so it can be used not only for peer-to-peer payments, but also for trading stock, bonds, or any other financial instrument.

The secure payment transaction system described in this invention is one type of a larger and more general system that supports the peer-to-peer exchange of any type of secure, private, and anonymous data and transactions in an open Internet environment using a public transactions ledger. A public transactions ledger is a public archive of all objects reflecting actions that have been performed in the system. Its main purpose is to provide data, mechanisms, and protocols to validate these transactions without the assistance of third parties. The objects, individually or sometimes grouped in blocks, are cryptographically encapsulated and mutually linked in a functional or time sequence. This concept of a public transactions ledger is known as a blockchain. Thus, this system, called the blockchain information exchange (BIX), is conceptually broader system and supports the validation of any type of secure, private, and anonymous peer-to-peer transaction using a public transactions ledger (blockchain). This system is called “Blockchain Information eXchange” (BIX) system. Accordingly, the virtual currency used in the system is called BIXCoin. Its value is pegged to real-world currencies and its unit value is equivalent to the U.S. dollar.

### SUMMARY OF THE INVENTION

The essence of any payment system is its procedure for validating legality and correctness of transactions. The core aspects of that procedure are verifying (a) that the sender has in his/her possession a sufficient amount of legal and correct virtual currency, one that is recognized and accepted by other participants in the system, and (b) that double-spending is impossible. Being in possession of legal virtual currency means that the currency in the sender's account has not been fabricated and the sender has a sufficient amount to pay the transaction. Prevention of double-spending means to prevent the user from spending the same amount of currency more than once. Both properties may be achieved by accurately updating a sender's account when performing payment transactions, so that his/her virtual account is correctly debited or credited and therefore always has the correct balance.

Using illegal virtual currency or using legal virtual currency but not correctly received to the sender's account means, in essence, printing money, as is double-spending. Therefore, it is clear that the solution for all illegal activities and problems in the system is verification of the correct balance of each account. If the balance of an account is correct, it means that the amount of currency at the sender's disposal is correct and therefore, payments based on such an account balance are correct. Bitcoin uses a very specific approach to validate account balances: it stores locally at user's workstation or mobile device the complete blockchain of all transactions performed in the system and reconstructs the sender's current account balance by tracing all transactions in the blockchain starting from the trusted “coinbase” transaction. This approach works, but it has many problems and disadvantages. First, the local copy of all transactions in the system is large; it is mainly redundant; and it requires long time to update. Second, transaction verification takes a long time, so the update of the recipient's virtual account, after the transaction is performed by the sender, is significantly delayed. Third, due to the use of public keys as account numbers, Bitcoin accounts are vulnerable to the theft of private keys.

The essence of the solution described in this invention is to store user accounts (and their balances) on the public ledger instead of transactions. In this way, (a) reconstructing the balance of an outgoing account is not needed, as the balance is readily available in the ledger; (b) updating the recipient's account balance is instantaneous; and (c) by keeping an account's chain of balances in the ledger, the account balance can be fully and accurately validated by tracing the account chain.

Another problem with unprotected peer-to-peer transactions is that after their completion, they can be illegally inserted, removed, or modified. To prevent this problem, including the illegal modification of complete blocks, Bitcoin uses two techniques: a special hashing protocol performed by miners and chaining of transactions blocks. In the system described in this invention, these illegal manipulations of payment data are prevented by the cryptographic encapsulation of accounts. This operation is instantaneous, i.e., much faster than Bitcoin's hashing procedure (proof-of-work). However, it is obvious that if these accounts, as data objects, are encapsulated by their owners, then they can be re-encapsulated after illegal manipulation. This reasoning leads to the conclusion that accounts belonging to individual users cannot be encapsulated by their owners. Because there are no third parties in the proposed system, the conclusion is that user accounts are updated and encapsulated by other users. This approach may seem strange—users cannot update, control, or protect their own accounts and their accounts are manipulated, maintained, updated, and protected only by other users. But, as it will be shown, this solution is very effective.

The next important distinction of this system compared to Bitcoin is that user accounts, when stored in the ledger, are not packaged in blocks. They are loaded and stored individually. This approach eliminates delays in validating components of the ledger and loads accounts into the ledger immediately after they are updated. The chain of accounts is represented by instances of the same account, with different balance values, each instance created as a result of a payment transaction. In this way, the history of every account and its balances can be traced from its opening, its initial loading, and up to and including its last transaction.

The system uses public key cryptography, key pairs, and certificates, all of which are managed by the special protocol and infrastructure described in a related invention. Important features of that certificate infrastructure are that (a) it is peer-to-peer and has no third parties (certificate authorities); (b) public and private keys are not used as account addresses and payment authorization tokens, but for standard security services; and (c) users may have multiple types of currencies and accounts, still protected with the same key pair and certificate.

Another important feature of the designed payment system is that accounts contain three types of identities of their owners: one for explicit identification, one for private transactions, and one for anonymous transactions.

Contrary to the procedures, data structures, and protocols for validating account balances in Bitcoin, the proposed system provides several verification levels, each suitable for different type of transactions. For small payments (e.g., micropayments), the verification level is low, but instantaneous. For transactions with high value (e.g., stock trading), the verification level is very high, providing fully accurate account verification, but it is slow. Finally, the special technique of using “validation points” in the ledger speeds up account validation, even when it is based on the full account chain. Validation points are instances of partners' accounts that have already been fully validated, so validation of new transactions can start from these instances treated as trusted account balances.

The remaining paragraphs provide a short description of a payment transaction between two partners—a sender and recipient—including the use of the public payments ledger, the messages exchanged, and the format and encapsulation of the accounts. Before initiating the payment transaction, each partner has stored his/her account object locally with the latest accurate account balance. Each account is digitally signed by the partner with whom the specific user performed the last payment transaction. Both accounts, in exactly the same form, are stored in and available from the payments ledger. Before initiating the payment, the partners exchange the identification of the accounts they want to use and agree on transaction details, i.e., the amount to be paid. The payment transaction starts when the recipient sends an invoice to the sender. The invoice is represented by the latest instance of the recipient's account object. This step may be performed in several different ways, depending on the mutual location (local or remote) of the partners, the technology used, and other digital commerce arrangements. In face-to-face payments, the recipient may pass his/her account object directly to the sender, or he/she may display account identification so that the sender fetches it from the ledger, or he/she may send account identification over-the-air for the sender to fetch account object from the public payments ledger. At the end of this step, the sender has the recipient's account object with its current balance.

Using data from that instance of the recipient's account, the sender creates a new instance of the recipient's account by the following steps: (1) he/she updates (credits) recipient's account balance, (2) indicates him/herself as the last transaction partner, (3) digitally signs the new instance of the recipient's account, and (4) sends it to the recipient, together with his/her own account. These steps and the transfer of the two accounts to the recipient represent the payment transaction.

After receiving the two accounts, the recipient modifies the sender's account accordingly: (1) he/she debits its balance, (2) indicates him/herself as the last transaction partner, (3) digitally signs the instance of the sender's account, and (4) submits both accounts to the public payments ledger. The updated instance of the sender's account represents the receipt. At the end of these steps, the communication system (push) or the sender him/herself (pull) gets his/her updated account from the payments ledger.

These two new instances of the sender's and recipient's accounts are now “entangled” objects—they are related to each other by the same transaction. A new instance of the sender's account was created and digitally signed by the recipient and a new instance of the recipient's account was created and digitally signed by the sender. Therefore, in this system, the transaction represents an ordered pair of account objects; the first object represents the sending party and the second object represents the receiving party. Each instance includes the hash of the previous instance of the account belonging to the same user and, in that way, all instances of one user's account are linked in the accounts chain. It is clear that, if needed, the balance of an account can be validated by following the account chain from its initial instance, when the account was opened, all the way up to the latest instance and its current balance

Each instance of the users' accounts also contains data for the specific transaction that was used to create the account instance. In that way, each instance of an account also represents the transaction and, therefore, the elements in the account chain can be interpreted as either account instances or individual transactions. This means that this system is a conceptual extension of the blockchain ledger used with Bitcoin. The difference is that the individual components in the designed public payments ledger are not packaged in blocks, but inserted into the ledger as individual objects, the solution which offers many functional advantages compared to the Bitcoin blockchain.

In the Detailed Description of the Invention section the components of the system are described, together with the structure of the account object, the details of all transactions, and the validation criteria and levels, including formal proof that cheating is impossible

### DESCRIPTION OF THE DRAWINGS

FIG. 1 shows the architecture and components of the BIX Payments System.

FIG. 2 shows the structure, attributes and segments of the BIX Account object in the ASN.1 encoded syntax

### DETAILED DESCRIPTION OF THE INVENTION

### 1. The Architecture and Components of the BIX Payments System

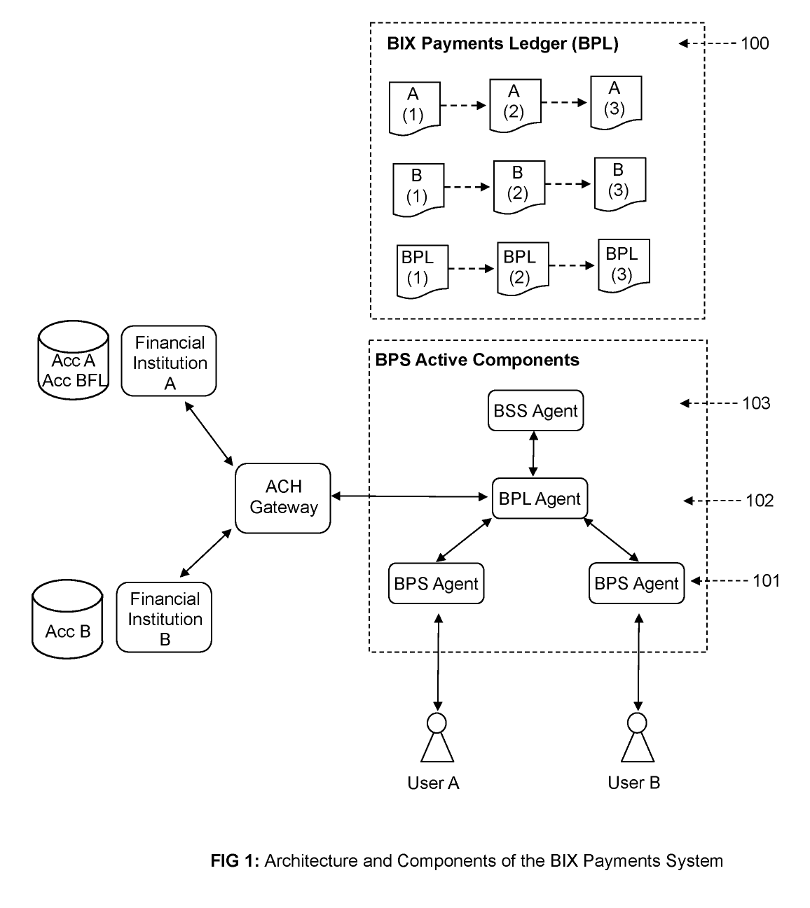

BIX Payments System comprises two types of components—active components and data components—as shown in FIG. 1. The active components are the following software, hardware, or combination modules:
The BIX Payments System Agent (BPS Agent) 101 software module, which is used by users to perform payments and other financial transactions. It has a graphical interface for users, business logic, a communication module, local database drivers, and cryptographic engines;
The BIX Payments Ledger Agent (BPL Agent) 102 software module, which is a client module that interacts with and maintains the BIX Payments Ledger. It has a graphical interface for administrators, business logic, communication module, database server interfaces, and cryptographic engines;
The BIX Synchronization System Agent (BSS Agent) 103 software module, which is a server module that performs messages and data synchronizations. It performs several types of secure instant messaging protocols, including one-to-one, one-to-many, one-to-all (broadcasting), system-to-user (push), and user-to-system (pull).

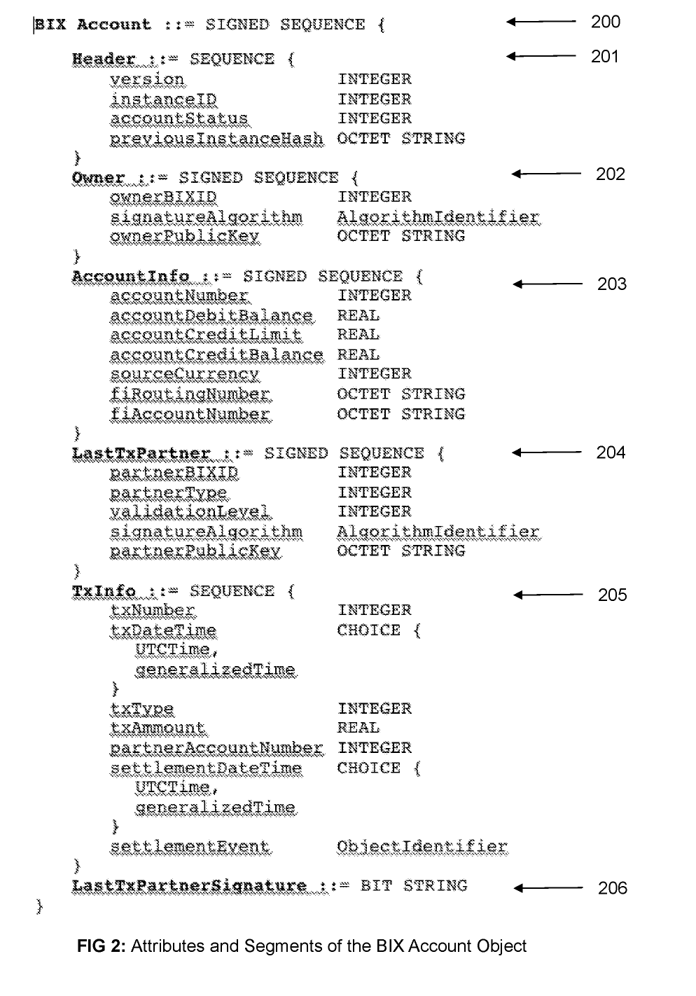

The data components are:
The BIX Account, 200 which is a cryptographically encapsulated and digitally signed data object containing several attributes and segments, including the identity of its owner, a virtual account with various financial attributes, the identity of the partner of the last payment transaction, and full information about the last payment transaction performed with the account. (The attributes and segments of the BIX Account object are shown in FIG. 2);
The BIX Payments Ledger, 100 which is a forward-linked list of BIX Accounts with multiple distributed and federated instances that reflect an account's transactions and its balances after each transaction.

BPL Agents play the central role in the operation of the BIX Payments System. They perform seven protocols: they (1) generate new amounts of virtual currency; (2) destroy certain amounts of virtual currency; (3) validate two BIX Accounts after the transaction parties have updated them in the process of performing a payment transaction; (4) write a BIX Account objects into the BIX Payments Ledger; (5) read a BIX Account objects from the BIX Payments Ledger; (6) assist in the process of settling delayed payments between BIX Accounts; and (7) perform the cancelation of a payment. BPL Agents are used by the members of the BIX System with special authorities, which will be described later. These members have their own BIX Accounts, which they use for a special type of financial transactions—collecting payments of service fees.

The relationships between these active and data components that comprise the architecture of the BIX System are the following: BPS Agents manage BIX Accounts on behalf of users, who are account owners; perform payment/settlement protocols with other users' BPS Agents; and interact with BPL Agents. BPL Agents maintain the BIX Payments Ledger and virtual currency of the BIX System through the seven protocols listed above, interact with financial institutions outside of the system, write into and read BIX Accounts from BIX Payments Ledger upon request by BPS Agents, and assist these Agents when performing the five protocols with BIX Accounts. BSS Agents interact with BPS Agents and synchronize users' registration numbers, enforce the accurate global timing of transactions and other events, and distribute BIX Account objects between BPS Agents and BPL Agents.

When creating an amount of new virtual currency (based on a user request), the BPL Agent charges a service fee payable by the requesting user in real currency. When destroying a certain amount of virtual currency from a specific BIX Account (also based on a user's request who is the account owner), the BPL Agent charges a service fee payable by the requesting user in virtual currency. For the validation of BIX Account objects and their insertion into the BIX Payments Ledger, BPL Agents charge the sender, recipient, or both parties a service fee payable in virtual currency.

Because the virtual currency in each BIX member's BIX Account is backed by the equivalent value of the member's real-world currency, each user also has a real-world financial account in some financial institution. Regular users use these accounts to pay the service fee to the BPL Agents when they generate new amounts of virtual currency on behalf of, and upon request by, users. The same accounts are used when BPL Agents remove virtual currency from a user's BIX Account. The real-world accounts in financial institutions that belong to the BPL Agents are used as escrow accounts that keep the real-world currency in the amount equivalent to the total value of the virtual currency generated on behalf of those users in the BIX System associated with the specific BPL Agent. These accounts are also used for two other purposes: (a) to keep the amount of real-world currency that belongs to the BPL Agents based on the amount of virtual currency collected in service fees, and (b) to transfer real-world currencies to the real-world accounts of the users who request that the BPL Agent destroys an amount of virtual currency from the BIX Account of the BIX member requesting that action.

### 2. BIX Account Protocols

The BIX System supports five protocols with BIX Accounts: (1) the opening of an account, (2) the initial loading of an amount of virtual currency into a newly opened account, (3) the clearing of the specific amount of virtual currency from an account, (4) payment/settlement, and (5) payment cancelation.

### 2.1 the Open New Account Protocol

The Open New Account protocol is performed by a BIX member when he/she wants to open a completely new BIX Account or an account with a source currency different from the source currency used in any of the user's existing accounts.

BIX Accounts can the status of initial, loaded, active, suspended, or terminated. The status of a BIX Account is indicated in the accountStatus attribute in the Header 201 segment. The status is initial after the account is opened by its owner, but before it is loaded with virtual currency.

The procedure for creating a new BIX Account is the following: the accountStatus attribute is set to initial. The previouslnstanceHash attribute in the Header segment is not populated. The Owner 202 segment is populated with data belonging to the account owner. If the account owner wants to have only account security, but not privacy and anonymity, then the ownerBIxID attribute is populated. Otherwise, it is not populated and only accountNumber is used to perform payment transactions. The LastTxPartner 204 segment is not populated. AccountInfo 203 is populated with a random number as the value of the accountNumber attribute, accountDebitBalance is set to zero (0), and sourceCurrency is appropriately encoded. Because in the next step, the account is used to load virtual currency by the BPL Agent, the two attributes, fiRoutingNumber and fiAccountNumber, are enveloped using the BPL Agent's public key, with which the user is associated. The TxInfo 205 segment is not populated. The account is digitally signed by the owner, as it has the initial status. The signature is placed in the LastTxPartnerSignature 206 attribute.

### 2.2 the Load New Account Protocol

The Load New Account protocol is performed by the BPL Agent upon request by the BIX member after the creation of the new BIX Account. The purpose of the protocol is to generate the requested amount of new BIXCoins and deposit them into the BIX Account of the user initiating the action.

The virtual currency used in the BIX System, called the BIXCoin, represents a unit of value. It is stable, as it is pegged to real-world currencies. Therefore, the virtual currency indicated by the balance of an account is always created by paying the fee in some source currency from the real-world for the service of generating an equivalent number of BIXCoins. This payment does not represent the purchase of BIXCoins, but simply the fee paid using a real-world currency for the service of generating the equivalent amount of virtual currency units. An alternative interpretation is that BIXCoin represents worldwide currency, so that all payment transactions are expressed and exchanged using a common monetary unit. For easier human understanding, when using BIXCoins to denominate the value of goods or services, the value of the BIXCoin is pegged to the U.S. dollar.

To recognize the different source currencies by which the BIXCoins are backed, BIX Accounts indicate the source currency that was used to pay the generation fee, which is specified in the sourceCurrency attribute of the AccountInfo 203 segment.

Upon receiving the request by the user, the BPL Agent first validates the account by checking its digital signature. If the signature is correct, the BPL Agent opens the envelope and retrieves the original values of the two attributes fiRoutingNumber and fiAccountNumber. Then, the BPL Agent generates a number of new BIXCoins and assigns it to the BIX Account of the requesting user. That new instance of the BIX Account is then inserted into the BIX Payments Ledger. The owner 202 segment of that BIX Account is the requesting user, but the value of the accountStatus attribute is changed to loaded. The number of new BIXCoins generated is added to the current value of the accountDebitBalance attribute and sourceCurrency is set to the appropriate currency code. LastTxPartner 204 is the BPL Agent, and TxInfo contains data about the new BIXCoins. The txType attribute is set to zero (0), indicating the initial load. The partnerType attribute is set to one (1), designating the BPL Agent who assisted the user in loading his/her BIX Account. Upon completion, the BPL Agent digitally signs the new instance of the account and the signature is placed in the LastTxPartnerSignature attribute.

For this action, the BPL Agent charges the user a service fee equivalent to the number of new BIXCoins expressed in U.S. dollars. That service fee is paid by the user in real-world currency using his/her real-world account at some financial institution. For that, the BPL Agent contacts the user's financial institution using the values in the fiRoutingNumber and fiAccountNumber attributes. The payment of the fee is performed when an amount of real-world currency is transferred from the real-world account of the user to the real-world account of the BPL Agent.

The transaction that loads a new BIX Account does not have another BIX Account as its source, but an institution dealing with real-world currencies. Because such transaction must be inserted into the BIX Payments Ledger, the conclusion is that it should be performed and supported by the BPL Agent. Business entities handling these Agents are BIX members with special authority to generate new BIXCoins. They validate the entities external to the BIX System—financial institutions, which handle real-world currencies to be used for paying service fees. Because these institutions are not the members of the BIX System, they must be assisted by BPL Agents. Therefore, these Agents represent the transaction partners for BIX members when loading new BIX Accounts. In case of anonymous accounts, which do not specify owner identities in the ownerBIXID attribute, BPL

Agents must validate that the BIX Account to be loaded using the specified financial institution indeed belongs to the owner of the real-world account. This verification is based on the special anonymous authentication procedure of account owners, which is the subject of another invention.

### 2.3 The Clear Account Protocol

The Clear Account protocol is performed by the BPL Agent on behalf of, and upon request by, the BIX member who owns the BIX Account that needs to be cleared. As a result of this action, the account balance is set to zero. This is the case when the owner of the BIX Account wants to suspend or terminate a virtual account. The protocol is equivalent but inverse from the load account protocol, but this time, the transaction does not have another BIX member as the recipient. In this case, the BPL Agent again plays an active role in the transaction. The request to clear the account is created by its owner in the form of a new instance of the account. The accountStatus attribute in the Header segment is set to either suspend or terminate, and the new instance is self-signed by the account owner and sent to the BPL Agent. The Agent creates the new instance of the BIX Account by setting its balance to zero. The attributes of the LastTxPartner 204 segment are then populated to designate the BPL Agent performing this action. This new instance of the BIX Account is then inserted into the BIX Payments Ledger.

For this service, the BPL Agent also charges a service fee as a percentage of the number of BIXCoins being cleared. That service fee is paid by the user using a portion of the BIXCoins being cleared. The value in real-world currency equivalent to the amount of BIXCoins being cleared (after the service fee) is transferred from the real-world account of the BPL Agent performing this action to the real-world account of the user who initiated the action.

### 2.4 The Payment/Settlement Protocol

The Payment/Settlement protocol is performed between two parties—the sender and the recipient—when they want to perform a payment transaction, i.e., to transfer an agreed upon number of BIXCoins from a virtual account that belongs to the sender to a virtual account that belongs to the recipient. Before executing the protocol, the two parties agree on an amount to be paid and each is in the possession of his/her own BIX Account with an accurate account balance. The protocol is then performed in six steps.

Step 1: The purpose of this step is for the recipient to issue an invoice to the sender. The invoice is represented by the current instance of recipient's BIX Account. If the two parties are in proximity of each other (over-the-counter protocol), the recipient displays his/her BIX Account number and the agreed upon amount on the screen of the digital device that the recipient's BIX transactions agent is running. The sender fetches the account number and amount, and based on the account number, requests that the BPS Agent 101 fetches the recipient's BIX Account from the BIX Payments Ledger 100. Alternatively, the recipient's BPS Agent directly sends BIX Account to the sender's BIX Agent over the proximity communication protocol. If the two parties are remote, then the recipient may either send his/her BIX Account directly to the sender using the BSS one-to-one protocol or may send only account number and the agreed upon amount, which the sender uses to request that the BPL Agent 101 fetches the BIX Account object from the BIX Payments Ledger by the BPL Agent. As a result of step 1, the latest instance of the recipient's BIX Account is available to the sender for processing by his/her BPS Agent.

Step 2: The purpose of this step is to make a payment, which the sender performs by updating the recipient's BIX Account object, i.e., by creating a new instance. The new instance is created through several steps.

First, before updating the BIX Account object of the transaction partner, the sender first verifies the correctness of the object by verifying the digital signature in the LastTxPartnerSignature 206 attribute. In that process, the hash of the current BIX Identity object is extracted. That hash is included in the previouslnstanceHash attribute in the Header 201 segment of the new instance of the BIX Account. The value of the instanceID attribute in the Header segment is increased by one from the current value of the instance=attribute.

Then, the segment Owner 202 is copied from the current instance of the BIX Account object.

BIX virtual accounts may be used for account-to-account payments but also for bankcard (debit and credit) payments. Because bankcard debit payments are equivalent to account-to-account payments in the sense that both use debit accounts, the BIX Account object uses the accountDebitBalance attribute for both types of payments. Therefore, accountDebitBalance is incremented by the payment amount. The other attribute in the AccountInfo 203 segment are copied from the current version of the recipient's account object.

After the payment transaction is complete, the LastTxPartner 204 segment designates the sender and is populated as follows: the partnerBIXID attribute is populated with the BIX ID of the recipient. The partnerType attribute (1—BPL Agent, 2—user) is set to two (2). The validationLevel attribute is set to one of the values 1-5 (see below), indicating which the validation procedure of the recipient's account balance was used. signatureAlgorithm represents the object identifier of the asymmetric key cryptographic algorithm, and partnerPublicKey represents the public key of the sender contained in his/her certificate.

The TxInfo 205 segment describes the current transaction, so it is populated as follows: txNumber is randomly generated; txDateTime is set to the current date and time received from the BSS Agent; txType is set to two (2) which is the code that indicates the transaction represents receiving payment—incoming transaction; txAmount is the amount to be paid; and partnerAccountNumber is the account of the sender from which the payment is made. Finally, settlementDateTime is the date and time when the transaction should be settled, in cases where it needs to be performed at some later time and not instantaneously. Alternatively, settlementEvent may be set to an identifier of an object that represents an event upon whose completion the transaction is settled. Examples of such events may be the receipt of goods (where the transaction represents an advanced payment) or completion of the contract (where the transaction represents a deposit).

After completion, the sender digitally signs the account using the algorithm designated in the signatureAlgorithm attribute and the private key that corresponds to the public key in the partnerPublicKey attribute of the LastTxPartner 204 segment. After signing, the sender sends the completed object to the BPL Agent together with the current instance of his/her own BIX Account. As a result of step 2, the recipient's updated BIX Account object and the sender's current (still not updated) BIX Account object are sent to the common BPL Agent.

Step 3: In this step, the BPL Agent sends both objects, sender's BIX Account object and recipient's BIX Account object, to the recipient.

Step 4: In this step, the recipient first validates the digital signature of his/her own updated BIX Account, checking that the sender has correctly updated his/her account balance. If so, as the next step, the recipient compares the payment amount with the sender's account balance. If it is greater, the transaction is invalid. If payment amount is less or equal to the sender's account balance, the recipient next validates the balance of the sender's account, which is contained in the sender's BIX Account object. This validation verifies that (a) the sender's account balance is greater than or equal to the transaction amount and (b) that the sender is in legitimate possession of the virtual currency in his/her BIX Account. For this validation, the sender may select one of the five account balance validation procedures described in the section 3.1, each giving a higher assurance level, but requiring shorter or longer validation times. If the account balance is correct and the sender has sufficient amount of virtual currency in the account, the recipient proceeds to the next step.

Step 5: In this step, the recipient updates the sender's BIX Account object. The Header 201 segment is updated accordingly by the sender in step 2. The LastTxPartner 204 segment is populated with the recipient's data and accountDebitBalance is debited by the transaction amount. The TxInfo 205 segment is copied from the recipient's account, except that txType attribute is set to one (1), indicating a sent payment, i.e. outgoing transaction. After completion, the recipient digitally signs the BIX Account object using the algorithm designated in the signatureAlgorithm attribute and the private key that corresponds to the public key included in the partnerPublicKey attribute. The recipient then sends the completed object to the BPL Agent. As a result of step 5, the sender's updated BIX Account object is sent to the common BPL Agent, so at the end of this step, the Agent is in possession of both updated BIX Account objects.

Step 6: In this step, the BPL Agent first validates the correctness of both accounts, so that they are consistent and correctly entangled with each other. If so, the Agent submits both account objects into the BIX Payments Ledger and also sends the sender's updated BIX Account object to the sender. At the end of this step, the payment transaction is complete, with both BIX Accounts updated and both available on the BIX Payments Ledger and to their individual owners.

### 2.5 The Cancel Transaction Protocol

The Cancel Transaction protocol cancels previously initiated or already settled payment transaction. In many real-life scenarios, canceling a transaction is very useful feature: a payment may be performed with an incorrect amount, it may be mistakenly directed to an incorrect recipient, or there may be problems in the shipment of tangible goods. In the BIX System this action may be performed under two circumstances: (a) before settlement of the transaction, which is step 6 in the payment/settlement protocol, or (b) after the settlement has been completed. If one of the parties in the transaction decides to cancel the transaction before its completion, then the sender in step 2 or the recipient in step 5, instead of sending the messages to the BPL Agent specified in the payment/settlement protocol, sends a cancel request message. Alternatively, before the transaction is settled, it can be canceled after step 5 of the payment/settlement protocol.

For this purpose, the settlementDateTime and settlementEvent attributes are used. If a payment transaction has no prerequisites for completion, but one of the parties wants to be able to cancel the transaction before its settlement, then the settlementDateTime attribute is populated. In this case, the value of that attribute indicates to the BPL Agent when to perform step 6 of the payment/settlement protocol. The settlement may also be conditioned by an event, which is then indicated by the settlementEvent attribute. This attribute contains an identifier of an object whose creation and insertion in some other supporting ledger represents the prerequisite for settling. When the object is created and its identifier is submitted to the BPL Agent, the Agent settles the payment transaction, i.e., performs step 6 of the payment/settlement protocol.

If one of the parties, most often the sender, wants to cancel the transaction after its settlement, such action requires reversal of the payment transaction. Because objects in the BIX Payments Ledger cannot be removed, reversal of the payment transaction means the creation of the two new instances of BIX Account objects, one for the sender and the other for the recipient of the original payment transaction. These instances are created by performing the transaction that represents the reverse of the original payment transaction. In both of these objects, the txType attribute indicates cancelation of the original transaction. Therefore, txAmount and txAccountNumber are the same as in the original transaction.

If the other transaction party agrees to the cancelation, then the cancel payment transaction is equivalent to the payment transaction. However, in some cases, the other party, most likely the recipient, may not voluntarily accept cancelation of the transaction. In this case, based on the operational policy of the Payment Ledger, the BPL Agent may intervene and send the amount to the original sender. For this transaction, the BPL Agent uses data in the BIX Account object belonging to the original recipient, retrieved from the Payment Ledger, and plays the role of the sender. The original sender plays the role of the recipient of the cancelation transaction. With these two entities playing the roles of sender and recipient, a cancelation transaction is equivalent to a payment transaction.

### 3. Security, Privacy, and Anonymity

### 3.1 Account Balance Validation Procedures and Assurance Levels

The following five procedures may be used to validate the balance of an account. At level 1, the procedure is very quick and efficient, but it provides the lowest level of assurance in correctness of the account balance. The higher the level, the higher the assurance, but the longer the procedures take. At the top, level 5, the procedure fully guarantees the correctness of the account balance and is equivalent to the procedure used in the Bitcoin system.

Level 1: validation is performed by checking the BIX Account object's digital signature, which is created by the BIX member with whom the sender performed the last transaction before the current transaction. The public key for that verification is included in the account object, in the partnerPublicKey attribute of the LastTxPartner segment. At this level the public key is not verified (using the certificate of the last transaction partner), so the recipient trusts the last transaction partner and his/her validation, which is indicated in the validationLevel attribute.

Level 2: validation is the same as at level 1, but the public key of the last transaction partner is verified using certificate of the last transaction partner.

Level 3: at this level all incoming and outgoing transactions of the sender's personal financial chain are verified using the procedure at level 1. All transactions are fetched from the BIX Payments Ledger.

Level 4: at this level the same procedure as at level 3 is used, but is extended with verification of the public keys of all partners using their certificates.

Level 5: at this level the sender's full account chain and chains of all his/her transaction partners are fetched from the BIX Payments Ledger and used to validate the account balance. In other words, it includes all balances of the sender's payment account and all other accounts that performed payment transactions with the sender's payment account, from their initial loading up to their current balance.

### 3.2 an Analysis of Cheating Scenarios

The BIX System is completely resistant to all attempts of cheating by any party. The assumption in this analysis is that all parties perform their functions as specified in the payment/settlement protocol, but attempt to use incorrect values for parameters and in different phases of the protocol. Cheating may be attempted during or after completion of the payment/settlement protocol.

Cheating during the payment/settlement protocol may be attempted in three ways, but all three can be easily detected and prevented:
(a) In step 2, the sender specifies a payment amount that is less than the agreed upon amount, i.e., the sender increments the accountBalance attribute in the recipient's BIX Account by an amount less than the agreed upon amount. However, this would be detected by the recipient in step 4;
(b) In step 2, the sender specifies a payment amount that is greater than the balance of his/her BIX Account. However, this would be detected by the recipient in step 4 by comparing accountBalance with the txAmount in the sender's BIX Account;
(c) In step 5, the recipient updates the sender's account balance with an amount that is greater than the agreed upon payment amount, i.e., accountBalance in the sender's BIX Account is debited with an amount that is greater than the payment amount. However, this would be detected by the BPL Agent in step 6.

Cheating after the completion of a payment transaction may be attempted in three ways:
(a) After completing the payment procedure, the sender may attempt to delete the two updated BIX Account objects from the Payments Ledger, thus regaining the balance of his/her BIX Account. However, this is impossible because the BIX Payments Ledger is append-only and entries in it cannot be deleted;
(b) The sender may attempt to modify a local copy of his/her BIX Account object by increasing its balance. However, this is impossible as the object is cryptographically signed by the last transaction partner;
(c) If the user attempts to collaborate with his/her last transaction partner to illegally re-sign an incremented account balance, in order to keep the system consistent that action would require that the last transaction partner also decrements the balance of his/her own account, which obviously an action not unacceptable to the partner. Even if the last transaction partner is willing to do that, he/she must collaborate further with his/her last transaction partner to modify his/her BIX Account object that corresponds to the account object being modified by the last transaction partner. This implies that such collaboration must be extended all the way to the head of the personal financial chain of the account being attempted to be illegally modified. The procedure would ultimately reach the BPL Agent, who would not participate in such an intervention;
(d) If the sender attempts to the reduce payment amount of the last completed transaction, thus incrementing his/her own BIX Account balance, that action would require re-signing of his/her BIX Account by the transaction partner who participated in the payment transaction that is being attempted to be illegally modified. To create an entangled BIX Account for such a modified account, that transaction partner must also modify his/her own BIX Account balance by reducing the payment amount of the transaction and therefore the balance of his/her own account. This action is not likely to be accepted by the transaction partner. Furthermore, if the transaction partner has already performed outgoing payment transactions, those transactions may become invalid due to the reduced account balance of the transaction partner or, at the very least, must be re-signed along the complete forward personal financial chain. Because all of these actions reduce the account balances of the BIX Accounts of all parties who made payments after the payment by the user attempting to reduce payment amount, such an action would not be accepted.

### 3.3 the Protection of Private Cryptographic Keys

The BIX System is completely resistant to any penetration and illegal use of the system by unauthorized users who attempt to steal the secret or sensitive parameters that belong to regular BIX users. The core cryptographic mechanism of the BIX System is public key cryptography. In all algorithms of that type, the sensitive and therefore secret element is a private key. If the private key is stolen, the intruder can steal the BIXCoins from the victim's BIX Account. Such an illegal action would be executed as a payment transaction where the intruder would have two roles—as the sender, using BIX Account of the victim, and also as the recipient, using his/her own BIX Account.

Many different suggestions and solutions for this problem exist in the literature, but they all have the same approach: protection of the private key by different security mechanisms. However, all such mechanisms, even if based on the use of smart cards, are not perfect and can be either bypassed or broken.

To effectively eliminate this threat, the obvious solution is not to store private keys anywhere in the system. The logic of this approach is simple: if a private key does not exist, it cannot be stolen. However, if a private key does not exist in the system, then it must be generated when needed in order to create digital signatures or open digital envelopes. But new private key cannot be generated whenever it is needed, because the corresponding public key and its certificate have already been distributed and are in possession of many BIX members. Therefore, the solution used in the BIX System is that a private key is generated when needed but in such a way that it cryptographically corresponds to the public key/certificate already in the system. This can be accomplished by using a deterministic procedure to generate a key pair, with the seed represented by the personal secret parameter memorized by the user and not stored in the system.

For two of the most popular asymmetric cryptographic algorithms the generation of a key pair is a deterministic procedure. For the Rivest-Shamir-Adleman (RSA) cryptographic algorithm, two prime numbers are generated first, then the modulus, then the private key (based on the convention that the value of the public key exponent is fixed and equal to 3 or 17). The procedure for generating two prime numbers is deterministic if it uses the seed. Using the user's login parameter (which has a fixed value) for that seed always generates the same key pair. The Elliptic Curve Digital Signature Algorithm (ECDSA) procedure is even simpler, as the private key in that algorithm is any random value selected in a specified interval. That random value can be easily generated deterministically by using the fixed seed.

To conclude, this innovative way to protect private cryptographic keys is that when a user logs into the BPS Agent, he/she gives his/her login parameter. This parameter is used as the seed to generate a private key, and that key is then used in a challenge/response authentication protocol to create digital signatures and open digital envelopes.

### 3.4 User Privacy and Anonymity

The privacy of users and their payment transactions is defined as the system property to not disclose user identities to any party in the system other than the current transaction partner. This property means that the identity of the transaction partner cannot be shared with any other party and that the payment transaction between two parties does not reveal the identities of the parties to any other party in the system. Anonymity is a property beyond privacy where even the partner in the payment transaction does not learn the identity of his/her transaction partner.

In the BIX System the identity of the user is the value of the ownerBIXID attribute in the Owner segment of the BIX Account. The identity of the last transaction partner is provided by the value of the partnerBIXID attribute in the LastTxPartner segment of the BIX Account. So, when a user sends his/her BIX Account with ownerBIXID and partnerBIXID populated, privacy and anonymity are not provided, as the current transaction partner learns the identity of the user and his/her last transaction partner. If only privacy is needed, then the user must conceal the values of these two attributes in such a way that (a) the transaction partner can recover them, but (b) the transaction partner cannot share them with other users. To achieve this, the user envelopes the values of both parameters using his/her transaction partner's public key, which is contained in the ownerPublicKey attribute of the Owner segment of each user's BIX Account. Such attributes can be recovered by recipients using their own private keys. But, if the recipient wants to share these identities with other parties in the system, he/she must also share his/her private key with them, which is obviously an action that is unacceptable to the recipient, as such an action would put the recipient's complete BIX Account at risk.

Enveloping the values of these two attributes for each transaction partner requires modification of the BIX Account. However, that is impossible, because the instance of the account is digitally signed by the last transaction partner. Therefore, to provide full anonymity of payment transactions, the identities of the transaction partners should not be populated in the BIX Account object. If anonymity is needed, then the ownerBIXID attribute is not populated when creating the account and the partnerBIXID attribute is not populated for the payment transaction. Only the accountNumber attribute in the AccountInfo segment and the partnerAccountNumber attribute in the TxInfo segment should be populated. To avoid impersonation, man-in-the-middle threats and other attacks, the use of anonymous BIX Accounts requires a special authentication procedure that is the subject of another invention.

1-21. (canceled)

22. A system for managing a virtual currency in a peer-to-peer computer network, comprising:
a plurality of computing devices in the peer-to-peer computer network, each computing device being associated with one or more system users;
a plurality of financial accounts, each financial account being associated with:
(i) a particular user of a particular computing device in the peer-to-peer computer network, and
(ii) a virtual currency that is linked to a value of at least one national currency in a country in which the system is deployed,
the plurality of financial accounts being stored in an electronic public transactions ledger maintained simultaneously at the plurality of computing devices in the peer-to-peer computer network;
a transactions ledger module operative to generate, destroy, update, and/or manage amounts of the virtual currency used in financial transactions by system users of the plurality of computing devices within the peer-to-peer computer network, wherein each financial transaction is associated with at least two financial accounts;
a plurality of payment modules operative to consummate the financial transactions between the one or more system users in the peer-to-peer computer network; and
a synchronization module operative to transmit transaction information corresponding to the financial transactions between the plurality of financial accounts and the electronic public transactions ledger.

23. The system of claim 22, wherein each of the plurality of financial accounts are virtual accounts that hold the virtual currency.

24. The system of claim 22, wherein each of the financial accounts comprises a cryptographically-encapsulated and digitally-signed data object.

25. The system of claim 22, wherein each of the financial accounts comprises the following attributes:
identity data uniquely identifying the user of the respective financial account;
partner identity data uniquely identifying the user of a partner financial account that was involved in a most recent financial transaction with the respective financial account;
recent transaction data defining aspects of the most recent financial transaction; and
financial institution data corresponding to a financial institution affiliated with the respective financial account.

26. The system of claim 22, wherein a particular financial account associated with a first system user comprises a data object that is cryptographically-encapsulated and digitally-signed for a second system user.

27. The system of claim 22, wherein the electronic public transactions ledger comprises a blockchain.

28. The system of claim 22, wherein the electronic public transactions ledger comprises a forward-linked and backward-linked list of the plurality of financial accounts associated with the system users, wherein each financial account includes an indication of each account's financial transactions and the virtual currency balance after each transaction.

29. The system of claim 22, wherein the transactions ledger module is further operative to:
validate the at least two financial accounts involved in each financial transaction;
read and/or write financial accounts into and/or from the electronic public transactions ledger;
settle delayed financial transactions between the at least two financial accounts; or
cancel financial transactions.

30. The system of claim 29, wherein the financial accounts are appended to the electronic public transactions ledger at an end-most portion of the electronic public transaction ledger.

31. The system of claim 22, wherein each payments module is further operative to:
manage financial accounts on behalf of respective system users;
perform payment protocols with respective payments modules of other system users; or
communicate with the transactions ledger module.

32. The system of claim 22, wherein the synchronization module is further operative to:
interact with payment modules to synchronize data on behalf of system users;
enforce and/or monitor global timing information corresponding to each financial transaction; or
distribute financial accounts between the transactions ledger module and each payment module.

33. The system of claim 22, wherein the electronic public transactions ledger is operative to instantaneously validate financial transactions within the peer-to-peer computer network.

34. The system of claim 22, wherein each of the plurality of financial accounts comprises an updatable amount of the virtual currency.

35. The system of claim 22, wherein the one or more system users are individual users and/or business entities.

36. A method for managing a virtual currency in electronic financial transactions associated with an electronic public transactions ledger maintained at a plurality of electronic computing devices in a peer-to-peer computer network, comprising the steps of:
receiving, at a first computing device associated with a first financial account having a first account balance of a virtual currency, an electronic request for a financial transaction transmitted from a second computing device associated with a second financial account having a second account balance of the virtual currency, the electronic request comprising an instance of the second financial account;
upon receipt of the electronic request for the financial transaction, creating, at the first computing device, a new instance of the second financial account;
electronically modifying, at the first computing device, the new instance of second financial account by:
updating the second account balance defined by the new instance of the second financial account according to the electronic request for the financial transaction;
indicating electronic modification of the new instance of the second financial account by the first financial account associated with the first computing device via an electronic identification number associated with the first financial account; and
electronically signing and cryptographically enveloping the new instance of the second financial account; and
transmitting, to the second computing device associated with the second financial account, the electronically-signed and cryptographically enveloped new instance of the second financial account reflecting the updated second account balance and an instance of the first financial account.

37. The method of claim 36, wherein the first and/or second financial accounts are virtual accounts that hold the virtual currency.

38. The method of claim 36, wherein the second computing device associated with the second financial account further performs the steps of:
creating a new instance of the first financial account;
electronically modifying the new instance of the first financial account by:
updating the first account balance defined by the new instance of the first financial account according to the electronic request for the financial transaction;
indicating electronic modification of the new instance of the first financial account by the second financial account via an electronic identification number associated with the second financial account; and
electronically signing and cryptographically enveloping the new instance of the first financial account; and
transmitting the electronically-signed and cryptographically enveloped new instance of the first financial account reflecting the updated first account balance and the electronically-signed new instance of the second financial account to the electronic public transactions ledger.

39. The method of claim 38, wherein the step of electronically signing the new instance of the first financial account is performed via a randomly generated bit string associated with the second financial account.

40. The method of claim 36, wherein the step of electronically signing the new instance of the second financial account is performed via a randomly generated bit string associated with the first financial account.

41. The method of claim 36, further comprising the step of prior to receiving, at the first computing device associated with the first financial account having the first account balance of the virtual currency, the electronic request for the financial transaction transmitted from the second computing device associated with the second financial account, exchanging transaction details defining the financial transaction between the first computing device and the second computing device.

42. The method of claim 41, wherein the transaction details comprise a payment amount of the virtual currency corresponding to the financial transaction and information corresponding to both the first financial account and the second financial account.

43. The method of claim 36, wherein each of the financial accounts comprises a cryptographically-encapsulated and digitally-signed data object.

44. The method of claim 36, wherein each of the financial accounts comprises the following attributes:
identity data uniquely identifying the user of the respective financial account; and
financial institution data corresponding to a financial institution affiliated with the respective financial account.

45. The method of claim 36, wherein the electronic public transactions ledger comprises a blockchain.

46. The method of claim 36, wherein the electronic public transactions ledger comprises a forward-linked and backward-linked list of at least the first financial account and the second financial account, wherein each financial account includes an indication of each account's financial transactions and the virtual currency balance after each transaction.

47. The method of claim 36, wherein the electronic public transactions ledger is operative to instantaneously validate the financial transaction within the peer-to-peer computer network.

48. The method of claim 36, wherein each of the financial accounts comprises an updatable balance of the virtual currency.

49. The system of claim 22, wherein the virtual currency comprises a blockchain-based virtual coin that is used as a unit of value for financial transactions in the system.

50. The system of claim 22, wherein the at least one national currency is the U.S. dollar.

51. The method of claim 36, wherein the virtual currency comprises a blockchain-based virtual coin that is used as a unit of value for financial transactions.

52. The method of claim 36, wherein the virtual currency is linked to a value of at least one national currency in a country in which the method is performed.

53. The method of claim 52, wherein the at least one national currency is the U.S. dollar.
